(19) United States
(12) Patent Application Publication
(10) Pub. No.: US 2025/0340713 A1
(43) Pub. Date: Nov. 6, 2025

(54) METHOD FOR DEPOLYMERISING POLYMERS INTO ONE OR MORE MONOMERS

(71) Applicants: SYNOVA RENEWABLE TECHNOLOGY B.V., Maassluis (NL); NEDERLANDSE ORGANISATIE VOOR TOEGEPAST-NATUURWETENSCHAPPELIJK ONDERZOEK TNO, The Hague (NL)

(72) Inventors: Abraham VAN DER DRIFT, Castricum (NL); Robin Willem Rudolf ZWART, Maassluis (NL); Rob SLANGEN, Bergen op Zoom (NL); Tom VANDERLOCHT, Koersel (BE)

(73) Assignees: SYNOVA RENEWABLE TECHNOLOGY B.V., Maassluis (NL); NEDERLANDSE ORGANISATIE VOOR TOEGEPAST-NATUURWETENSCHAPPELIJK ONDERZOEK TNO, The Hague (NL)

(21) Appl. No.: 18/865,717

(22) PCT Filed: May 15, 2023
(86) PCT No.: PCT/NL2023/050270

§ 371 Date: Nov. 14, 2024

(30) Foreign Application Priority Data
May 16, 2022 (NL) 2031868

(51) Int. Cl. C08J 11/12; C10B 49/10; C10B 53/07

(52) U.S. Cl. CPC C08J 11/12; C10B 49/10; C10B 53/07

(57) ABSTRACT

Method for depolymerising polymers into one or more monomers. A fluidised reactor system is provided comprising a pyrolysis chamber (2), a combustion chamber (12), and bed material that circulates from the combustion chamber (12) to the pyrolysis chamber (2) via a transport zone (30). A feedstock comprising 60% or more polymers by weight of the feedstock is inputted into the pyrolysis chamber (2) and a pyrolysis process is executed at a temperature in the range of from 450 to 650° C. in the bed material to provide a depolymerised polymer product gas comprising the monomers. Circulation of the bed material allows for sufficient heat to be transferred from the combustion chamber (12) to the pyrolysis chamber (2) to execute the pyrolysis process.

### FIELD

The present invention relates to an improved method for depolymerising polymers into one or more monomers. Even more specifically the improved method is for increasing the yield of the one or more monomers by reducing side reactions and the level of contaminants present in a depolymerised polymer product gas.

### BACKGROUND

WO2008/108644 and WO2014/070001 disclose a device for producing a product gas from biomass. Fuel (e.g. biomass) supplied to a riser in a reactor usually comprises 80% by weight of volatile constituents and 20% by weight of substantially solid carbon or char. Heating the biomass supplied to the riser to a temperature higher than 800° C., such as between 850-900° C., in a low-oxygen or oxygen free environment results in pyrolysis of the biomass and production of a product gas. The solid carbon and char only undergoes pyrolysis to a limited extent, and it is therefore necessary to combust this material in a separate combustion zone of the reactor.

U.S. Pat. Nos. 10,731,080 and 11,041,123 disclose methods for recycling waste plastics, including a system for recovering styrene monomer from waste polystyrene. Waste stream is first densified in a melt before being sent to a continuously fed non-catalytic pyrolysis system. The pyrolysis system includes a heated self-cleaning dual-screw reactor which provides heat, via different heating zones, to crack or depolymerise the plastic feedstock. Such screw reactor systems exhibit poor temperature control, large temperature gradients, and inevitably result in over-cracked plastics.

WO2021/053074 and WO2021/053075 disclose a method for the depolymerisation of polystyrene based on fluidised bed technology. The polystyrene is fed into a pyrolysis reactor and is fluidised and heated by steam. Use of steam in such a way results in a product gas which is significantly diluted and requires additional complex techniques to recover the styrene.

It is also known to use a pyrolysis reactor that is fluidised and heated with air. A disadvantage of using heated air in a pyrolysis reactor is that it may result in charring of products. A further disadvantage is that the combustion products are diluted with nitrogen and carbon dioxide which reduces the efficiency of downstream condensation. The reduction in downstream condensation efficiency is due to a decrease in the dewpoint of the condensing components.

It is therefore an object of aspects of the present invention to address one or more of the above-mentioned or other problems.

### SUMMARY OF THE INVENTION

In a first aspect, the invention concerns a method for depolymerising polymers into one or more monomers, comprising: (a) providing a fluidised reactor system comprising a pyrolysis chamber, a combustion chamber, and bed material that circulates from the combustion chamber to the pyrolysis chamber via a transport zone; and (b) inputting a feedstock comprising 60% or more polymers by weight of the feedstock into the pyrolysis chamber and executing a pyrolysis process at a temperature in the range of from 450 to 650° C. in the bed material to obtain a depolymerised polymer product gas comprising the monomers; wherein upon circulating the bed material sufficient heat is transferred from the combustion chamber to the pyrolysis chamber to execute the pyrolysis process.

In a second aspect, the invention concerns a use of a fluidised reactor system comprising a pyrolysis chamber, a combustion chamber, and bed material that circulates from the combustion chamber to the pyrolysis chamber via a transport zone, for depolymerising polymers in a feedstock comprising 60% or more polymers by weight of the feedstock into one or more monomers.

Furthermore, all defined features for the method according to the invention equally applies to the use according to the invention, and vice versa.

The method according to the invention enables heat generated in the combustion chamber to be transferred to the pyrolysis chamber via circulation of the bed material. The bed material is continuously circulated from the combustion chamber to the pyrolysis chamber preferably via a closed system or loop. Put another way, the bed material is continuously circulated preferably via a closed loop between the combustion chamber and the pyrolysis chamber.

The temperature difference between the combustion chamber and the pyrolysis chamber may be increased by decreasing the circulation rate of the bed material. This allows for higher combustion temperatures and thereby enables low temperature to be maintained in the pyrolysis chamber. A further advantage is the prevention or minimisation of over-cracking of the polymers which increases the yield of the monomer products. Increasing the circulation rate may also prevent or minimise side reactions. The circulation rate of the bed material may be from 10 to 100 kg bed material circulated per kg feedstock, more preferably 20 to 60 kg per kg.

The temperature difference between the combustion chamber and the pyrolysis chamber may be decreased by increasing the circulation rate of the bed material. This enables higher temperatures to be achieved in the pyrolysis chamber. The circulation rate of the bed material may be from 10 to 100 kg bed material circulated per kg feedstock, more preferably 20 to 60 kg per kg.

Furthermore, providing heat directly via the bed material results in the polymer mixture being exposed to substantially uniform temperatures in the pyrolysis chamber as all the heat, or substantially all the heat for the pyrolysis process, is provided by the bed material. In contrast, conventional heating techniques that provide heat indirectly through the wall of the pyrolysis reactor container or via internal heat tubes results in temperature hot spots and high surface temperatures. These temperature hot spots and high surface temperatures result in over-cracking of polymers. For example, the temperature at or near the chamber wall of conventional naphtha crackers can easily be 200° C. higher than the temperature needed for the cracking of naphtha and naphtha gases. Thus, providing heat via the bed material prevents or minimises side reactions, such as cracking of the product monomers, and consequently the yield of monomer products is increased.

The hot bed material is preferably sand, such as crystal quartz sand.

The pyrolysis process may be executed from 400 to 700° C., preferably 450 to 650° C., even more preferably 450 to 600° C. The pyrolysis process temperature is chosen depending on the type of polymer(s) used, i.e. the temperature at which the polymers depolymerise.

In the combustion chamber the combustion process is executed at a higher temperature than the pyrolysis process. In the combustion chamber the combustion process may be executed at a temperature in the range of from 30 to 130° C. higher than the pyrolysis process, preferably 30 to 70° C. For example, the pyrolysis process is executed at a temperature in the range of from 400 to 700° C. and the combustion process is executed at a temperature in the range of from 30 to 130° C. higher than the pyrolysis process. By way of further example, the pyrolysis process is executed at a temperature in the range of from 450 to 650° C. and the combustion process is executed at a temperature in the range of 30 to 70° C. higher than the pyrolysis process. Temperatures above 750° C. are undesirable in the pyrolysis chamber as the monomer units are cracked further to provide a product gas comprising light hydrocarbon gases, heavy hydrocarbon oil fractions and solid residues. Lowering the temperature reduces the amount of these fractions.

Fluidisation gas may be transferred into the transport zone, typically from a product recovery unit of the fluidised reactor system to control the circulation rate of the bed material. Fluidisation gas may be transferred into the transport zone at more than one region. Preferably the temperature difference between the combustion chamber and the pyrolysis chamber is increased or decreased by changing the ratio of fluidisation gas transferred into a first region of the transport zone relative to a second region of the transport zone. In a preferred embodiment the transport zone comprises a first region to allow the downflow of bed material from the combustion chamber and a second region to allow the upflow of bed material to the pyrolysis chamber. The fluidisation gas may be transferred into an upstream portion of the second region and into a downstream portion of the second region. The term upstream portion and downstream potion is taken to indicate the direction of flow of the bed material through the fluidised reactor system. Put another way, the bed material is circulated from the first region into the upstream portion and subsequently circulated into the downstream portion before being transferred to the pyrolysis chamber. Fluidisation gas may be transferred into the pyrolysis chamber, typically from a product recovery unit (40) of the fluidised reactor system, to control the circulation rate of the bed material.

The circulation rate of the bed material may by increased or decreased by altering the amount of fluidisation gas transferred into the transport zone and/or the pyrolysis chamber. The associated advantages of increasing and decreasing the circulation rate of the bed material is discussed above. The circulation rate of the bed material may by increased or decreased by altering the amount of fluidisation gas transferred into more than one region of the transport zone. Thus, changing the amount of fluidisation gas can decrease or increase the temperature difference between the combustion chamber and pyrolysis chamber by increasing or decreasing the circulation rate of the bed material, as described above. Preferably, fluidisation gas is only transferred into the second region of the transport zone, or put another way no fluidisation gas is transferred into the first region of the transport zone.

A particulate removal unit may be provided in communication with the product recovery unit so that the depolymerised polymer product gas may be transferred to the product recovery unit via the particulate removal unit. Solid particulate, such as ash, may be transferred from the particulate removal unit to the combustion chamber.

In a preferred embodiment the circulation rate of the bed material is decreased by adding more fluidisation gas into the downstream portion of the second region than the upstream portion of the second region. Here the ratio of fluidisation gas added to the upstream portion relative to the downstream portion is 1:1-6, typically 1:1.5-4. The circulation rate of the bed material is increased by adding less fluidisation gas into the downstream portion of the second region than the upstream portion of the second region. Here the ratio of fluidisation gas added to the upstream portion relative to the downstream portion is 1-6:1, typically 1.5-4:1.

In a further preferred embodiment, the circulation rate of the bed material is decreased by adding more fluidisation gas into the downstream portion of the second region and/or the pyrolysis chamber than the upstream portion of the second region. Here the ratio of fluidisation gas added to the upstream portion relative to the downstream portion and/or the pyrolysis chamber is 1:1-6, typically 1:1.5-4. The circulation rate of the bed material is increased by adding less fluidisation gas into the downstream portion of the second region and/or the pyrolysis chamber than the upstream portion of the second region. Here the ratio of fluidisation gas added to the upstream portion relative to the downstream portion 35 and/or the pyrolysis chamber is 1-6:1, typically 1.5-4:1.

Fluidisation gas may also be transferred into the first region. This facilitates circulation of bed material to the pyrolysis chamber. The fluidised reactor system therefore allows different amounts of fluidisation gas to be added to the transport zone and/or pyrolysis chamber and thereby control the transfer rate during operation. A further advantage of providing more than one region to add fluidisation gas is in case part of the region becomes blocked or partially blocked.

The method may further comprise (c) transferring the depolymerised polymer product gas into a product recovery unit and isolating the one or more monomers.

The fluidisation gas may be transferred from the product recovery unit. Alternatively, or in 5 addition to, the fluidisation gas may be transferred from an external source. The fluidisation gas may be transferred into the transport zone and/or the pyrolysis chamber from the product recovery unit.

Fluidisation gas may be transferred into the combustion chamber from an external source. Put another way, the fluidisation gas used in the combustion chamber is not derived from the product recovery unit. The fluidisation gas introduced into the combustion chamber may be air.

The velocity of the fluidisation gas in the second region of the transport zone may be from 0.5 to 3 m/s, preferably from 1 to 2.5 m/s, even more preferably 2 m/s. The velocity of the fluidisation gas in the upstream portion and/or downstream portion of the second region of the transport zone may be from 0.5 to 3 m/s, preferably from 1 to 2.5 m/s, even more preferably 2 m/s. This velocity range allows for movement of the bed material by actually fluidising the bed material.

The velocity of the fluidisation gas in the pyrolysis chamber may be from 3 to 7 m/s, preferably from 4 to 6 m/s. These velocity ranges allow for entrainment of the bed material through the pyrolysis chamber to the settling chamber. A further advantage of these velocity ranges is that they enable the bed material to be blown out of the pyrolysis chamber and circulated into the combustion chamber.

The velocity of the fluidisation gas is dependent on the density of the fluidisation gas and on the particle size of the bed material. Generally the particle size has greater influence than the density of the fluidisation gas.

The bed material may have a dp50 of from 240 to 280 μm, preferably 260 μm. Average particle sizes are determined using laser diffraction particle size analysis, for example using a Malvern Mastersizer.

The feedstock may be provided as flakes with a thickness of from 0.25 to 3 mm. For example, the feedstock may be sourced from waste streams, wherein the waste streams are provided as flakes with a thickness of from 0.25 to 3 mm. At least 50% of the feedstock may be provided as flakes, preferably at least 75%, even more preferably at least 90%. The dp50 of the bed material may be lower to avoid the flakes being blown out of the riser before being depolymerized. By way of example, flakes with a thickness of from 0.25 to 3 mm would benefit from the dp50 of the bed material to be reduced to 100 to 240 μm, preferably 180 μm. The waste streams may comprise a PS waste stream, such as a PS yogurt cup waste stream.

The density of the fluidisation gas in the transport zone may be from 0.9 to 1.1 kg/Nm³, preferably 1.0 kg/Nm³. The density of the fluidisation gas in the upstream portion and/or the downstream portion of the second region of the transport zone may be from 0.9 to 1.1 kg/Nm³, preferably 1.0 kg/Nm³. The density of the fluidised bed material in the transport zone may be from 900 to 1100 kg/m³, preferably 1000 kg/m³. The density of the fluidised bed material in the upstream portion and/or the downstream portion of the second region of the transport zone may be from 900 to 1100 kg/m³, preferably 1000 kg/m³.

In an embodiment, the velocity of the fluidisation gas in the upstream portion and/or the downstream portion of the second region of the transport zone may be from 0.5 to 3 m/s, preferably from 1 to 2.5 m/s, even more preferably 2 m/s; the bed material has a dp50 of from 240 to 280 μm, preferably 260 μm; and the density of the fluidisation gas in the upstream portion and/or the downstream portion of the second region of the transport zone may be from 0.9 to 1.1 kg/Nm³, preferably 1.0 kg/Nm³.

The velocity of the bed material in the first region may be from 0.05 to 0.15 m/s, preferably 0.1 m/s. The density of the bed material may be from 1440 to 1760 kg/m³, preferably 1600 kg/m³.

In an upper portion (downstream portion) and/or lower (upstream portion), of the pyrolysis chamber the velocity of the fluidisation gas may be from 3 to 7 m/s, preferably from 4 to 6 m/s. The density of the fluidised bed material in the upper portion and/or lower portion of the pyrolysis chamber may be from 90 to 110 kg/m³, preferably 100 kg/m³. The density of the fluidisation gas in the upper portion and/or lower portion of the pyrolysis chamber may be from 2.25 to 2.75 kg/Nm³, preferably 2.50 kg/Nm³.

The fluidisation gas may be treated before being transferred to the fluidised reactor system. The fluidisation gas may be treated by either washing it in a neutral, acidic, or caustic scrubber to remove inorganic components such as HCN, NH₃, HCl, H₂S or COS. In addition, or alternatively, the fluidisation gas may be treated through use of a catalytic bed to hydrogenate olefins and thereby avoids olefins reacting with each other, for example via polymerization reactions to produce heavier hydrocarbons. In addition, or alternatively, the fluidisation gas may be treated by passing it through a suitable membrane to remove hydrogen from the fluidisation gas. This prevents or reduces contaminants entering the pyrolysis chamber and/or combustion chamber. The fluidisation gas is preferably produced from the product gas of the pyrolysis process and has a low moisture content. Accordingly, the product gas produced in the pyrolysis chamber may be transferred to the product recovery unit and the separated fluidisation gas may be recycled back into the pyrolyse chamber and/or transferred to the transport zone. The depolymerised product gas within the pyrolysis chamber may have a water dew point from 10 to 40° C., preferably 10 to 30° C. The fluidisation gas from the product recovery unit may have a water dew point from 0 to 10° C., preferably 5° C. The low moisture content of the fluidisation gas helps to reduce the water dewpoint of the depolymerised polymer product gas which is beneficial for optimising recovery of the building block monomers. Introduction of the fluidisation gas from the product recovery unit into the pyrolysis chamber helps to minimise/reduce the water dewpoint of the depolymerised polymer product gas produced by the pyrolysis chamber. A further advantage of adding the fluidisation gas to the pyrolysis chamber is to dilute the depolymerised polymer product gas to prevent or reduce polymerisation of the monomer units. The rate of dilution may be from 0.2 to 1.0 kg gas/kg hydrocarbon. By way of example, the product gas may comprise mono/di/trimers (C₈H₈, C₁₆H₁₆ and C₂₄H₂₄), olefins (C₂H₄, C₃H₆), and H₂. Through removal of components with a 1:1 H:C ratio and circulating 2:1 olefins or H₂ the risk of soot formation is reduced, which is in accordance with carbon formation equilibrium isotherms. Fluidisation gas with high hydrogen content helps to reduce soot formation within the pyrolysis chamber.

An advantage of transferring the non-condensable gas back into the pyrolysis chamber is associated with the high hydrogen content. The gas is non-condensable at ambient conditions, i.e. at or near atmospheric conditions and at a temperature in a range from 5 to 20° C.

Preferably the method further comprises transferring a fraction produced by the pyrolysis process into the combustion chamber and executing a combustion process in the hot bed material to provide a flue gas. The fraction may comprise unconverted char.

The method may further comprise transferring the flue gas of the combustion chamber and at least a portion of the non-condensable gas and/or energy source from the product recovery unit to a heat recovery system, wherein the heat recovery system comprises an afterburner. The term ‘fluidisation gas’ may be used interchangeably with the term ‘non-condensable gas’ and ‘energy source’. Preferably, the flue gas and at least a portion of the non-condensable gas and/or the energy source is sent to an afterburner of the heat recovery system to combust molecules (such as methane) that cannot be combusted in the low temperatures used in the combustion chamber. The amount of non-condensable gas sent to the afterburner/heat recovery system may be from 40% to 75% by weight of the total non-condensable gas, preferably from 60% to 70%. Sending part of the non-condensable gas directly to the afterburner/heat recovery system and not indirectly via the combustion chamber helps to maintain the temperature of the pyrolysis chamber and combustion chamber at a sufficiently low level when the combustion chamber is operated over-stoichiometrically and thereby prevents or minimises side reactions such as cracking. The combustion chamber may also be run sub-stoichmetrically. When run sub-stoichiometrically the non-condensable gas may be introduced into the combustion chamber before being sent to the afterburner/heat recovery system. Preferably, the combustion chamber is run sub-stoichiometrically with a surplus of non-condensable gas to allow for selective combustion of the non-condensable gas.

The terms sub-stoichmetrically and over-stoichiometrically are defined by a value for lambda. Lambda represents the ratio of the amount of oxygen present in a combustion chamber compared to the amount that should have been present in order to obtain “perfect” combustion. Therefore, when a mixture contains the exact amount of oxygen required to burn the fuel present, the ratio will be one to one and lambda will equal 1.00. When operated sub-stoichiometrically lambda may be from 0.4 to 0.7, typically 0.6. When operated over-stoichiometrically lambda may be from 1.2 to 1.3.

The fluidisation gas is more suitably referred to as non-condensable gas or energy source when being used or transferred to a part of the fluidised reactor system that does not use the gas or energy source as a fluidising agent, for example when the fluidisation agent is transferred from the product recovery unit to the combustion chamber. The method may therefore further comprise isolating non-condensable gas and/or an energy source from the depolymerised polymer product gas and optionally transferring at least a portion of the non-condensable gas and/or energy source to the combustion chamber. This advantageously compensates for low internal carbon transport. The non-condensable gas may comprise CO, H₂, CH₄, fractions of N₂, monomers, and combinations thereof. The energy source may comprise fossil fuel, solid biomass, waste feedstock, hydrocarbon condensate from the product recovery, or combinations thereof. A further advantage may be to provide sufficient energy for the pyrolysis process. The energy source may be a gas, liquid or solid. An advantage of transferring the non-condensable gas/energy source into the combustion chamber is that the non-condensable gas or energy source acts as an energy source and thereby compensates for low residual char transported internally as well as via a particulate removal unit (for example a cyclone) when used. Preferably an excess of non-condensable gas or energy source is transferred into the combustion chamber than required to provide sufficient energy for the combustion reaction. For example, the non-condensable gas or energy source may comprise easy to combust gases which can be combusted in the combustion chamber and less combustible gases which can only be combusted in the afterburner/heat recovery system. Thus, providing an excess of non-condensable gas or energy source ensures that adequate amounts of easy to combust gases are provided. The ratio of non-condensable gas from the product recovery system introduced directly into the afterburner/heat recovery system relative to the amount introduced into the combustion chamber is between 0 and 0.25, preferably 0 and 0.10. If temperatures in the combustion chamber are high enough, the combustion can be performed with an excess of air, and most of the non-condensable gas would be sent directly to the afterburner.

The method may further comprise hydrogenating olefins present in the non-condensable gas and/or the energy source prior to being transferred to the pyrolysis chamber.

The method may further comprise transferring at least a portion of the non-condensable gas and/or the energy source from the product recovery unit to the pyrolysis chamber to fluidise the pyrolysis chamber. Advantageously this minimises the water dewpoint of the depolymerised polymer product gas. A further advantage of transferring the non-condensable gas and/or the energy source into the pyrolysis chamber is to dilute the depolymerised polymer product gas to reduce the risk of polymerisation of the monomer units.

At least a portion of the non-condensable gas and/or the energy source may be used for the production of chemicals, preferably hydrogen and/or olefins from the non-condensable gas and/or the energy source are used for the production of chemicals. For example, olefins may be converted into methanol. By way of further example, olefins may be converted into benzene, toluene or xylene via aromatization.

The fluidisation gas, non-condensable gas or energy source may comprise olefins and hydrogen. Optionally, olefins and hydrogen may be recovered from a portion of the fluidisation gas. Optionally, the olefins may be converted into benzene, ethylene and xylene by catalytic aromatisation. Based on total weight, the fluidisation gas may comprise 30 to 50% of hydrogen by weight of the fluidisation gas. The fluidisation gas may comprise 10 to 40% of olefins by weight of the fluidisation gas, preferably 15 to 30%. Based on total volume, the fluidisation gas may comprise 30 to 50% of hydrogen by volume of the fluidisation gas. The fluidisation gas may comprise 10 to 40% of olefins by volume of the fluidisation gas, preferably 15 to 30%.

The fluidised reactor system may further comprise a downcomer to allow bed material to circulate from the pyrolysis chamber to the combustion chamber. The downcomer may be positioned coaxially around the pyrolysis chamber. In use, the bed material flows over an upper portion of the pyrolysis chamber into the downcomer and then circulates into the combustion chamber. A layer of bed material therefore always surrounds the pyrolysis chamber and acts as an insulation layer between the walls of the pyrolysis chamber and the downcomer. This reduces radial transfer of heat from the combustion chamber to the pyrolysis chamber and thereby prevents the walls of pyrolysis chamber from being heated to high temperatures which could result in further cracking.

The fluidisation gas and/or non-condensable gas/energy source velocities are controlled by flow transmitters within the fluidised reactor system.

The combustion chamber may be arranged to surround at least a portion of the pyrolysis chamber. The pyrolysis chamber may be arranged centrally or substantially centrally within the combustion chamber.

The method may further comprise transferring the depolymerised polymer product gas from the pyrolysis chamber to a particulate removal unit (for example comprising a cyclone) prior to being transferred to the product recovery unit. The cyclone advantageously removes sufficient solid particulate from the product gas to provide a suitable solid particulate to hydrocarbon ratio in the product gas.

The method may further comprise isolating dimers and trimers from the depolymerised polymer product gas and transferring the dimers and trimers to the pyrolysis chamber. This enables the dimers and trimers to be further cracked into monomer units and thereby increase the yield of the isolated monomers.

The method may further comprise inputting the feedstock into the pyrolysis chamber via a feeding screw. In one embodiment, the feedstock feeding rate, preferably through the feeding screw, is from 0.3 to 1.0 m/s.

Preferably the feedstock comprises from 5% to 15% of water by weight of the feedstock, more preferably from 5% to 10%. Preferably the feedstock comprises from 1% to 10% of ash by weight of the feedstock, preferably from 2% to 5%.

Alternatively, the polymers comprises from 5% to 15% of water by total weight of the polymers, more preferably from 5% to 10%. Preferably the polymers comprises from 1% to 10% of ash by total weight of the polymers, preferably from 2% to 5%.

A pressure control valve may be used to regulate the pressure of the depolymerised polymer product gas out of the pyrolysis chamber to the product recovery unit. An advantage of using the pressure control valve is that it compensates for the changing pressure differential of the depolymerised polymer product gas between the pyrolysis chamber and the product recovery unit to ensure a constant operating pressure for the depolymerised polymer product gas.

The term polymer is taken to mean any type of feedstock/fuel comprising polymers. The polymer is typically present in a mixture comprising the polymer. Within the mixture, the polymer may be combined with other polymers and/or with non-polymeric components. For example, the feedstock may contain biomass or biogenic waste, plastic waste (such as linear hydrocarbon plastic waste) or binders and fillers present in plastics. By way of further example, the feedstock may comprise polymer(s). Preferably the feedstock comprises 60% or more polymers by weight of the feedstock, preferably 80% or more. The term polymers is taken to mean at least one polymer.

The polymer mixture may be polystyrene, polyvinylchloride, polymethyl methacrylate, polytetrafluorethylene, or combinations thereof. Preferably the polymer mixture comprises predominately one or more of polystyrene, polyvinylchloride, polymethyl methacrylate or polytetrafluorethylene. Even more preferably the polymer mixture predominately comprises polystyrene. The polymer mixture may comprise from 60 to 100% of polystyrene, polyvinylchloride, polymethyl methacrylate or polytetrafluorethylene by weight of the total polymers in the polymer mixture, preferably from 80 to 100%. The polymer mixture may comprise from 60 to 100% of polystyrene by weight of the total polymers in the polymer mixture, preferably from 80 to 100%.

According to a further aspect of the invention there is provided a use of a fluidised reactor system comprising a pyrolysis chamber (2), a combustion chamber (12), and bed material that circulates from the combustion chamber (12) to the pyrolysis chamber (2) via a transport zone (30), for depolymerising polymers into one or more monomers.

A pyrolysis process may be executed at a temperature in the range of from 400 to 750° C., preferably from 450 to 650° C. in the bed material to obtain the depolymerised polymer product gas comprising the monomers.

A temperature difference between the combustion chamber and the pyrolysis chamber may be regulated by changing the ratio of fluidisation gas transferred into a first region of the transport zone relative to a second region of the transport zone.

A temperature difference between the combustion chamber and the pyrolysis chamber may be increased or decreased by changing the circulation rate of the bed material.

The embodiments as described above may also summarised by the following clauses.
1. Method for depolymerising polymers into one or more monomers, comprising:
   (a) providing a fluidised reactor system comprising a pyrolysis chamber (2), a combustion chamber (12), and bed material that circulates from the combustion chamber (12) to the pyrolysis chamber (2) via a transport zone (30); and
   (b) inputting a polymer into the pyrolysis chamber (2) and executing a pyrolysis process at a temperature in the range of from 400 to 750° C. in the bed material to obtain a depolymerised polymer product gas comprising the monomers;
   wherein upon circulating the bed material sufficient heat is transferred from the combustion chamber (12) to the pyrolysis chamber (2) to execute the pyrolysis process.
2. The method according to clause 1, wherein the pyrolysis process is executed from 400 to 700° C., preferably 450 to 650° C.
3. The method according to clause 1 or 2, wherein in the combustion chamber a combustion process is executed at a temperature in the range of from 30 to 130° C. higher than the pyrolysis process, preferably 30 to 70° C.
4. The method according to any preceding clause, wherein the temperature difference between the combustion chamber (12) and the pyrolysis chamber (2) is increased by decreasing the circulation rate of the bed material, and wherein the temperature difference between the combustion chamber (12) and the pyrolysis chamber (2) is decreased by increasing the circulation rate of the bed material.
5. The method according to clause 4, wherein the circulation rate of the bed material is from 10 to 100 kg bed material circulated per kg feedstock, more preferably 20 to 60 kg per kg.
6. The method according to any preceding clause, wherein fluidisation gas is transferred into the transport zone (30), typically from a product recovery unit (40) of the fluidised reactor system, to control the circulation rate of the bed material.
7. The method according to clause 6, wherein fluidisation gas is transferred into the transport zone (30) at more than one region.
8. The method according to clause 7, wherein the temperature difference between the combustion chamber (12) and the pyrolysis chamber (2) is increased or decreased by changing the ratio of fluidisation gas transferred into a first region of the transport zone relative to a second region of the transport zone.
9. The method according to any preceding clause, wherein the transport zone (30) comprises a first region (32) to allow the downflow of bed material from the combustion chamber (12) and a second region (34) to allow the upflow of bed material to the pyrolysis chamber (2).
10. The method according to clause 9, wherein fluidisation gas is transferred into an upstream portion (36) of the second region (34) and into a downstream portion (35) of the second region (34).
11. The method according to any of clause 6 to 10, wherein the velocity of the fluidisation gas in the transport zone (30) is from 0.5 to 3 m/s, preferably from 1 to 2.5 m/s.
12. The method according to clause 10, wherein the velocity of the fluidisation gas in the upstream portion (36) and/or downstream portion (35) is from 0.5 to 3 m/s, preferably from 1 to 2.5 m/s, even more preferably 2 m/s.
13. The method according to any preceding clause, wherein fluidisation gas is transferred into the pyrolysis chamber (2), typically from a product recovery unit (40) of the fluidised reactor system, to control the circulation rate of the bed material.
14. The method according to clause 13, wherein the velocity of the fluidisation gas in the pyrolysis chamber (2) is from 3 to 7 m/s, preferably from 4 to 6 m/s.
15. The method according to any preceding clause, further comprising (c) transferring the depolymerised polymer product gas into a product recovery unit (40) and isolating the one or more monomers.
16. The method according to clause 15, further comprising isolating non-condensable gas and/or an energy source from the depolymerised polymer product gas.
17. The method according to clause 16, further comprising transferring at least a portion of the non-condensable gas and/or energy source to the combustion chamber (12).
18. The method according to clause 16 or 17, further comprising transferring flue gas from the combustion chamber (12) and at least a portion of the non-condensable gas and/or the energy source from the product recovery unit (40) to a heat recovery system, wherein the heat recovery system comprises an afterburner (58).
19. The method according to any one of clauses 16 to 18, further comprising transferring at least a portion of the non-condensable gas and/or the energy source to the pyrolysis chamber (2) to fluidise the pyrolysis chamber.
20. The method according to clause 19, further comprising hydrogenating olefins present in the non-condensable gas and/or the energy source prior to being transferred to the pyrolysis chamber (2).
21. The method according to any one of clauses 16 to 20, wherein at least a portion of the non-condensable gas and/or the energy source is used for the production of chemicals, preferably hydrogen and/or olefins from the non-condensable gas and/or the energy source are used for the production of chemicals.
22. The method according to any one of clauses 15 to 21, further comprising isolating dimers and trimers from the depolymerised polymer product gas and transferring the dimers and trimers to the pyrolysis chamber (2).
23. The method according to any preceding clause, wherein the combustion chamber (12) is run sub-stoichiometrically.
24. The method according to any preceding clause, wherein the polymer mixture comprises predominately one or more of polystyrene, polyvinylchloride, polymethyl methacrylate or polytetrafluorethylene, preferably polystyrene.
25. Use of a fluidised reactor system comprising a pyrolysis chamber (2), a combustion chamber (12), and bed material that circulates from the combustion chamber (12) to the pyrolysis chamber (2) via a transport zone (30), for depolymerising polymers into one or more monomers.
26. Use of the fluidised reactor system according to clause 25, wherein a pyrolysis process is executed at a temperature in the range of from 400 to 750° C. in the bed material to obtain the depolymerised polymer product gas comprising the monomers.
27. Use of the fluidised reactor system according to clause 25 or 26, wherein a temperature difference between the combustion chamber and the pyrolysis chamber is regulated by changing the ratio of fluidisation gas transferred into a first region of the transport zone relative to a second region of the transport zone.
28. Use of the fluidised reactor system according to any one of clauses 25 to 27, wherein a temperature difference between the combustion chamber and the pyrolysis chamber is increased or decreased by changing the circulation rate of the bed material.

### BRIEF DESCRIPTION OF DRAWINGS

FIG. 1 shows a schematic view of a reactor system according to an embodiment of the present invention.

### DESCRIPTION OF EMBODIMENTS

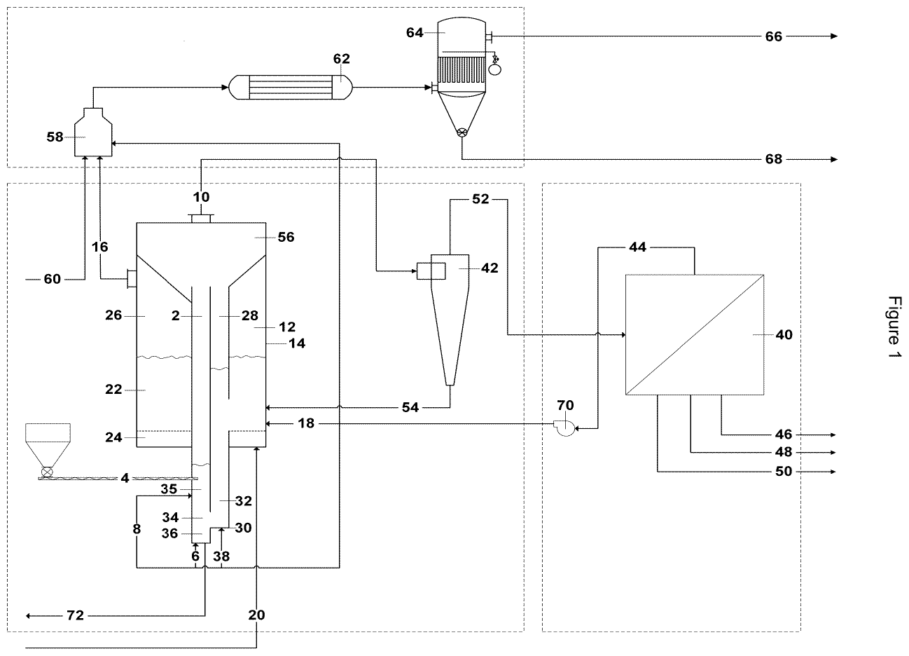

In an embodiment shown in the schematic view of FIG. 1, a fluidised reactor system is provided for depolymerising polymers into one or more monomers. The reactor system comprises a pyrolysis chamber 2 connected to a polymer mixture input 4 (which may comprise a polymer silo), a first fluidisation gas input 6, a second fluidisation gas input 8, and a product gas output 10. A combustion chamber 12, delimited by a wall 14, at least partially surrounds the pyrolysis chamber 2 and is connected to a flue gas output 16 and a non-condensable gas or energy source input 18. The non-condensable gas or energy source input is arranged to provide a source of combustible gas to the combustion chamber 12 to heat the bed material. The combustion chamber 12 is also connected to an external fluidisation gas input 20. The combustion chamber 12 comprises a fluidised bed zone 22, an air chamber 24 located beneath the bed zone 22, and a freeboard 26 located above the fluidised bed zone 22. A downcomer 28 is also provided to allow the bed material, char and fractions of the product gas (typically 1 to 2% by weight of the total weight of the product gas) to be transferred from the pyrolysis chamber 2 to the combustion chamber 12. The pyrolysis chamber 2 and the combustion chamber 12 are connected via a transport zone 30. The transport zone 30 comprises a first region 32 to allow the downflow of bed material from the combustion chamber 12 and a second region 34 to allow the upflow of bed material to the pyrolysis chamber 2. The second region 34 comprises a downstream portion 35 and an upstream portion 36. The first region 32 is connected to a third fluidisation gas input 38 for providing fluidisation gas to the pyrolysis chamber 2 via the transport zone 30. The pyrolysis chamber 2 is connected to the first fluidisation gas input 6 via the transport zone 30. Or put another way, the first fluidisation gas input 6 is connected to the upstream portion 36 of the second region 34 to allow the flow of fluidisation fluid into the second region 34 so that the fluidisation liquid is transferred to the pyrolysis chamber 2. The pyrolysis chamber 2 may be connected to the second fluidisation gas input 8 via the transport zone 30. Or put another way, the second fluidisation gas input 8 is connected to the downstream portion 35 of the second region 34 to allow the flow of fluidisation fluid into the second region 34 so that the fluidisation liquid is transferred to the pyrolysis chamber 2. Alternatively, the second fluidisation gas input 8 is directly connected to the pyrolysis chamber 2 to allow the flow of fluidisation fluid directly into the pyrolysis chamber 2. The second region 34 may be part of the pyrolysis chamber 2. The transport zone 30 is for circulating bed material between the combustion chamber 12 and the pyrolysis chamber 2. The product gas output 10 may be directly connected to a product recovery unit 40 (which may comprise one or more quench columns) or alternatively connected to a particulate removal unit 42 such as a cyclone. The product recovery unit 40 comprises a fluidisation/non-condensable gas output 44 in fluid communication with the first, second and third fluidisation gas inputs 6, 8 and 38 as well as energy source input 18. The product recovery unit 40 further comprises several product outputs, such as a monomer outlet 46, a dimer outlet 48 and a trimer outlet 50. The particulate removal unit 42 comprises a product gas output 52 in communication with the product recovery unit 40. The particulate removal unit 42 also comprises a solids output 54 which is in communication with the combustion chamber 12 for introducing solid, such as ash, into the combustion chamber 12.

In use, the bed material (preferably sand, such as crystal quartz sand) is continuously circulated between the pyrolysis chamber 2 and the combustion chamber 12 via the downcomer 28 and the transport zone 30. A polymer mixture is introduced into the pyrolysis chamber 2, via the polymer mixture input 4, and a pyrolysis process is executed at a temperature in the range of from 400 to 750° C., preferably 450 to 650° C., in the bed material to provide a depolymerised polymer product gas and a side-fraction. The side-fraction is transferred from the pyrolysis chamber 2 to the combustion chamber 12 (via a settling chamber 56 and the downcomer 28) by the bed material and combusted in the fluidised bed zone 22 at a at a temperature in the range of from 30 to 130° C. higher than the pyrolysis process in the presence of air to provide a flue gas which is used to heat the bed material in the combustion chamber 12. The flue gas then exits the combustion chamber 12 via the freeboard. The flue gas comprise one or more of N₂, CO2, H₂O and components of the non-condensable gas (see Table 8). The flue gas may also comprise one or more of the following contaminants: NOx, SOx and HCl. The bed material retains the heat of the combustion process and upon circulation of the bed material from the combustion chamber 12 to the pyrolysis chamber 2, via the transport zone 30, this heat is used in the pyrolysis process. Use of heat derived from the combustion process to pyrolyse the polymer mixture in the pyrolysis chamber 2 results in a temperature difference between the combustion chamber 12 and the pyrolysis chamber 2. Increasing the circulation rate of the bed material reduces the temperature difference between the combustion chamber 12 and the pyrolysis chamber 2, and thereby enables lower temperatures to be achieved in the combustion chamber 2. The lower temperatures achieved mean that at the bottom section of the pyrolysis zone temperatures lower reducing the risks of over-cracking. Decreasing the circulation rate of the bed material increases the temperature difference between the combustion chamber 12 and the pyrolysis chamber 2, and thereby allows for higher combustion temperatures while enabling low temperature to be maintained in the pyrolysis chamber 2.

The first, second and third fluidisation gas inputs 6, 8, and 38, external fluidisation gas input 20, and energy source input 18 may advantageously be used in combination with each other or in isolation from one another. The first, second and third fluidisation gas inputs 6, 8 and 38, external fluidisation gas input 20, as well as the energy source input 18 are used to control the temperature in the pyrolysis chamber 2 and combustion chamber 12. The fluidisation gas/non-condensable gas (preferably the tail gas) from the product recovery unit 40 is used to control the flow rate of the bed material through the transport zone 30. In particular, the velocity of the fluidisation gas in the second region 34 of the transport zone 30 may be from 0.5 to 3 m/s, preferably from 0.5 to 2 m/s. The velocity of the fluidisation gas in the pyrolysis chamber 2 may be from 3 to 7 m/s, preferably from 4 to 6 m/s.

The first fluidisation gas input 6 transfer fluidisation gas into the upstream portion 38 of the second region 34 of the transport zone 30. The second fluidisation gas input 8 transfers fluidisation gas into downstream portion 35 of the second region 34 of the transport zone 30. The third fluidisation gas input 38 transfers fluidisation gas into first region 32 of the transport zone 30. The external fluidisation gas input 20 transfers fluidisation gas into the air chamber 24 of the combustion chamber 12. The bed material flows from the first region 32 of the transport zone 30 to the second region 34 of the transport zone 30. In the first region 32 fluidisation gas flows downwardly away from the combustion chamber 12. In the second region 34 fluidisation gas flows upwardly towards from the combustion chamber 12 and into the pyrolysis chamber 2. Fluidisation gas may be transferred into the pyrolysis chamber 2 to control the circulation rate of the bed material. The circulation rate of the bed material may by increased or decreased by altering the amount of fluidisation gas transferred into the transport zone 30 and/or the pyrolysis chamber 2.

The circulation rate of the bed material is decreased by adding more fluidisation gas into the downstream portion 35 of the second region 34 than the upstream portion 36 of the second region 34. Here the ratio of fluidisation gas added to the upstream portion 36 relative to the downstream portion 35 is 1:1-6, typically 1:1.5-2. The circulation rate of the bed material is increased by adding less fluidisation gas into the downstream portion 35 of the second region 34 than the upstream portion 36 of the second region 34. Here the ratio of fluidisation gas added to the upstream portion 36 relative to the downstream portion 35 is 1-6:1, typically 1.5-4:1. Alternatively, the circulation rate of the bed material is decreased by adding more fluidisation gas into the downstream portion 35 of the second region 34 and/or the pyrolysis chamber 2 than the upstream portion 36 of the second region 34. Here the ratio of fluidisation gas added to the upstream portion 36 relative to the downstream portion 35 and/or the pyrolysis chamber 2 is 1:1-6, typically 1:1.5-2. The circulation rate of the bed material is increased by adding less fluidisation gas into the downstream portion 35 of the second region 34 and/or the pyrolysis chamber 2 than the upstream portion 36 of the second region 34. Here the ratio of fluidisation gas added to the upstream portion 36 relative to the downstream portion 35 and/or the pyrolysis chamber is 1-6:1, typically 1.5-4:1. Fluidisation gas may also be transferred into the first region 32. The fluidised reactor system therefore allows different amounts of fluidisation gas to be added to the transport zone 30 and/or pyrolysis chamber 2 and thereby control the transfer rate during operation.

The flow rate of the fluidisation gas may be the same for each of the first, second and third fluidisation gas inputs 6, 8 and 38. Alternatively, the flow rate of the fluidisation gas may be different for one or more of the first, second and third fluidisation gas inputs 6, 8 and 38. Preferably the fluidisation gas is derived from the product recovery unit 40 and is transferred out of the product recovery unit 40 to the first, second and third fluidisation gas inputs 6, 8 and 38 via the fluidisation gas/non-condensable gas output 44. The depolymerised polymer product gas is preferably transferred to the particulate removal unit 42 to remove solid particulate before being transferred to the product recovery unit 40. The depolymerised polymer product gas is transferred from the product gas output 10 of the pyrolysis chamber 2 to the particulate removal unit 42. Subsequently the depolymerised polymer product gas is transferred from the product gas output 52 of the particulate removal unit 42 to the product recovery unit 40. A pressure control valve may be used to regulate the pressure of the depolymerised polymer product gas out of the pyrolysis chamber 2 to the product recovery unit 40. An advantage of using the pressure control valve is that it compensates for the changing pressure differential of the depolymerised polymer product gas between the pyrolysis chamber 2 and the product recovery unit 40 to ensure a constant operating pressure for the depolymerised polymer product gas. The gas ash removed by the particulate removal unit 42 may be transferred to the combustion chamber 12 via solids output 54.

The depolymerised polymer product gas in the product recovery unit 40 is sorted and isolated into one or more product streams which are then transferred out of the product recovery unit 40 using one or more outlets (such as monomer outlet 46, dimer outlet 48 and trimer outlet 50). Dimer and trimer products may be transferred back to the pyrolysis chamber 2 to undergo further pyrolysis or might be used as an alternative energy source for the combustion chamber 12. Typically the dimer and trimer products are added opposite the polymer mixture input 4. Alternatively, the dimer and trimer products are added with the polymer mixture. Other non-polymer products may also be isolated such as tars, which may be transferred back to the pyrolysis chamber 2 to undergo further pyrolysis or to be used as an alternative energy source for the combustion chamber 12. Tars may comprise alkyl styrene, benzene, alkyl benzene, cycloalkanes, alkyl cycloalkanes, naphthalene, or combinations thereof. The type of polymer products depends on the type of polymer or polymers used in the polymer mixture. For example, polystyrene (PS) provides the monomer styrene, polyvinylchloride (PVC) provides the monomer vinyl chloride (VC), polymethyl methacrylate (PMMA) provides the monomer methyl methacrylate (MMA), and when polytetrafluorethylene (PTFE) is used tetrafluoroethylene (TFE) is the monomer. The flue gas from the combustion chamber 12 and/or a portion of or all the non-condensable gas from the product recovery unit 40 may be transferred to an afterburner 58 which forms part of a heat recovery system. Use of an afterburner 58 is preferred as the temperature within the combustion chamber 12 is insufficient to combust all the components of the side mixture. An air supply 60 is provided to the afterburner 58 to further combust the gasses at elevated temperatures, such as from 850 to 950° C., preferably from 850 to 900° C. These temperature ranges comply with waste incineration directives while avoiding melting of ashes and hazardous chemicals. The hot flue gas is then transferred to a flue gas cooler 62 before being transferred to a flue gas filter 64, where two product streams are obtained which are cleaned flue gas stream 66 and a fly ash stream 68. The ratio of non-condensable gas from the product recovery system 40 introduced directly into the afterburner 58 relative to the amount introduced into the combustion chamber 12 is between 0 and 0.25, preferably 0 and 0.10. If temperatures in the combustion chamber 12 are high enough, the combustion can be performed with an excess of air, and most of the non-condensable gas is sent directly to the afterburner 58. A recycling blower 70 may also be provided to increase the pressure of the fluidisation/non-condensable gas from the product recovery unit 40 before downstream circulation.

The polymer mixture input 4 may comprise a feeding screw. Feeding screws often exhibit high operating temperatures as of backflow of gas and/or bed material which may result in melting of the polymer mixture within the screw feed and subsequent blockage of the screw feed. Introducing the polymer mixture via fuel feeding at a sufficiently high rate reduces the temperature of the feeding screw. Preferably the fuel feeding rate expressed in velocity through the feeding screw is from 0.3 m/s to 1.0 m/s. The temperature of the feeding screw may also be reduced by leading the screw and its closed casing through the air chamber towards the pyrolysis zone, with the 60 to 80° C. air cooling the outside of the casing. The temperature of the feeding screw may also be reduced through addition of water and/or ash to the polymer mixture. Alternatively, the polymer mixture may have sufficient water content if derived from biomass, and therefore no additional water need be added to the polymer mixture. The polymer mixture preferably comprises from 5% to 15% of water by weight of the polymer mixture, more preferably from 5% to 10%. The polymer mixture preferably comprises from 1% to 10% of ash by weight of the polymer mixture, preferably from 2% to 5%. Bottom ash may be removed from the combustion chamber 12 via an ash output 72. More specifically, the bottom ash may be transferred from the combustion chamber 12 to the transport zone 30 and then removed via the ash output 72. By way of example, a 2% amount of ash provides 40% coverage of polymer particles with a 1 mm layer of ash.

### EXAMPLES

The following three polystyrene mixtures were tested (see Table 1).

TABLE 1

| Plastics (wt %) | PS mix A | PS mix B | PS mix C |
|---|---|---|---|
| Polystyrene | 80.0 | 81.3 | 89.1 |
| Polybutadiene (PBD) | 3.9 | 4.1 | 7.7 |
| Acrylonitrile (AN) | 0.8 | 0.8 | — |
| Polyethylene (PE) | 2.1 | 2.9 | — |
| Polypropylene (PP) | 3.6 | 4.2 | — |
| Polyethylene | 0.5 | 0.2 | — |
| terephthalate (PET) | | | |
| Others | 9.1 | 6.5 | 3.2 |

Polystyrene mixtures B and C were depolymerised at temperatures between 380° C. and 700° C. using the method according to the invention and the amount of styrene measured (see Table 2). The highest styrene yield was obtained at 600° C. for PS mix B and PS mix C.

TABLE 2

| Temperature (±3° C.) | PS mix B | PS mix C |
|---|---|---|
| 380 | — | 0 |
| 460 | — | 10 |
| 500 | — | 56 |
| 525 | — | 67 |
| 545 | — | 75 |
| 600 | 100 | 100 |
| 650 | 52 | 89 |
| 700 | 15 | — |

Polystyrene mixtures A and B were depolymerised at a temperature of 580° C. using the method according to the invention (i.e. where heat is provided through use of hot bed material circulating internally between the pyrolysis zone and the combustion zone) and the amount of styrene measured (see Table 3).

TABLE 3

| | PS mix A | PS mix B |
|---|---|---|
| Total input (kg) | 92.6 | 90.8 |
| Total liquids collected (kg) | 74.2 | 77.3 |
| Total liquids collected (wt %) | 80.1 | 85.1 |
| Product gas (wt %) | 4.7 | 4.7 |
| Tar (wt %) | 3.6 | 3.8 |
| Char (wt %) | 4.3 | 1.7 |
| Ash (wt %) | 2.1 | 2.0 |
| Total collected (wt %) | 94.7 | 97.2 |
| Styrene from feed (wt %) | 54 | 57 |
| Styrene from polystyrene (wt %) | 67 | 70 |

Table 4 shows the sand flow and sand to fuel ratio as a function of the fluidisation gas velocity through the transport zone 30. The operating temperature of the pyrolysis chamber 2 may be altered by adding more fluidisation gas into the no-flow region 36 and less into the upflowing region 34 or the pyrolysis chamber 2. This redistribution of fluidisation gas changes the temperature difference between the pyrolysis chamber 2 and the combustor chamber 12, as the flow of fluidisation gas (i.e. sand) through the transport zone 30 can be increased without having to mechanically modify the size of the transport zone 30. By increasing velocity this can be increased considerably.

TABLE 4

| | Fluidisation velocity (m/s) | | | | |
|---|---|---|---|---|---|
| Sand transport | 3.1 | 4.3 | 5.4 | 6.6 | 7.8 |
| Sand flow (kg/hr) | 180 | 194 | 212 | 245 | 289 |
| Sand to fuel ratio (—) | 36 | 39 | 42 | 49 | 58 |

Tests determining the melting behavior of three types of plastic (polypropylene (PP), polyethylene (PE) and polystyrene (PS)) were also performed. It was shown that these plastics could start to melt at temperatures between 140 and 200° C. without becoming a low viscous liquid (see Table 5). This behavior could potentially result in plastic blockage inside a feeding screw which conventionally operate at high temperatures.

TABLE 5

| Phase | PP | PE | PS |
|---|---|---|---|
| Start of deformation | 173° C. | 134° C. | 148° C. |
| Melting behaviour | 194° C. | 139° C. | 173° C. |
| Liquid plastic | 231° C. | 194° C. | 231° C. |

In order to reduce the operating temperature of the feeding screw it was found that high fuel feeding of PS and high fuel feeding of PS in combination with water reduces the operating temperatures of the feeding screw and thereby avoids melting of the polystyrene mixture in the screw feed (see Table 6).

TABLE 6

| Feeding phase | Feeding screw temperature |
|---|---|
| No fuel feeding | 450° C. |
| Feeding 6 kg/hr PS mix A | 100° C. |
| Feeding 6 kg/hr PS mix A | 80° C. |
| and addition of 10% water | |

It was found using conventional cyclones that high amounts of ash (fines) were not separated from the depolymerised polymer product gas. This proved to be problematic in the quench system of the product recovery unit as the condensed depolymerised polymer product exhibited increased viscosity as a result of the large ash content. Therefore, a new cyclone was applied for the purpose of allowing sufficient time for the ash particles to agglomerate within the cyclone to aid in separation of the ash particles from the depolymerised polymer product gas. The cyclone therefore is smaller than conventional cyclones to have more interaction between the particles, though taller to create sufficient residence time for particles to agglomerate. Table 7 shows the particle size distribution of ash remaining in the depolymerised polymer product gas in mg/Nm³ as a function of the inlet particle size distribution.

TABLE 7

| | | | Outlet | | | |
|---|---|---|---|---|---|---|
| Particle size | | | 109 | 139 | 580 | 779 |
| distribution | | Inlet | mg/Nm³ | mg/Nm³ | mg/Nm³ | mg/Nm³ |
| <0.01 | μm | 0.0 | 0.0 | 0.0 | 0.0 | 0.0 |
| <0.05 | μm | 0.5 | 0.0 | 0.0 | 1.0 | 0.0 |
| <0.1 | μm | 1.0 | 2.6 | 0.0 | 5.0 | 0.5 |
| <0.5 | μm | 3.5 | 30.0 | 50.0 | 69.0 | 66.0 |
| <1 | μm | 5.5 | 48.0 | 67.5 | 78.0 | 77.0 |
| <5 | μm | 16.0 | 92.0 | 100.0 | 100.0 | 100.0 |
| <10 | μm | 32.0 | 100.0 | 100.0 | 100.0 | 100.0 |
| <50 | μm | 90.0 | 100.0 | 100.0 | 100.0 | 100.0 |
| <100 | μm | 99.0 | 100.0 | 100.0 | 100.0 | 100.0 |
| <500 | μm | 100.0 | 100.0 | 100.0 | 100.0 | 100.0 |

Table 8 shows the individual components of the fluidisation gas/non-condensable gas/energy source derived from depolymerising polystyrene at 580° C. along with the associated auto-ignition temperatures.

TABLE 8

| Component | Fraction (mol %) | AIT (° C.) |
|---|---|---|
| Carbon monoxide (CO) | 2.53 | 609 |
| Hydrogen (H₂) | 40.82 | 500 |
| Carbon dioxide (CO₂) | 4.80 | — |
| Water (H₂O) | 0.65 | — |
| Methane (CH₄) | 10.59 | 595 |
| Nitrogen (N₂) | 15.65 | — |
| Argon (Ar) | 0.12 | — |
| Acetylene (C₂H₂) | 0.01 | 305 |
| Ethylene (C₂H₄) | 9.79 | 440 |
| Ethane (C₂H₆) | 2.79 | 515 |
| Propylene (C₃H₆) | 7.00 | 458 |
| Butadiene (C₄H₈) | 4.59 | 415 |
| Cyclopentane (C₅H₁₀) | 0.49 | 320 |
| Ammonia (NH₃) | 0.14 | 651 |
| Hydrogen cyanide (HCN) | 0.05 | 538 |

1. A method for depolymerising polymers into one or more monomers, comprising:
(a) providing a fluidised reactor system comprising a pyrolysis chamber, a combustion chamber, and bed material that circulates from the combustion chamber to the pyrolysis chamber via a transport zone; and
(b) inputting a feedstock comprising 60% or more polymers by weight of the feedstock into the pyrolysis chamber and executing a pyrolysis process at a temperature in the range of from 450 to 650° C. in the bed material to obtain a depolymerised polymer product gas comprising the monomers; wherein upon circulating the bed material sufficient heat is transferred from the combustion chamber to the pyrolysis chamber to execute the pyrolysis process.

2. The method according to claim 1, wherein the feedstock comprises predominately one or more of polystyrene, polyvinylchloride, polymethyl methacrylate or polytetrafluorethylene.

3. The method according to claim 1, wherein;
in the combustion chamber a combustion process is executed at a temperature in the range of from 30 to 130° C. higher than the pyrolysis process; the temperature difference between the combustion chamber and the pyrolysis chamber is increased by decreasing the circulation rate of the bed material, and wherein the temperature difference between the combustion chamber and the pyrolysis chamber is decreased by increasing the circulation rate of the bed material; and/or
the circulation rate of the bed material is from 10 to 100 kg bed material circulated per kg feedstock.

4. (canceled)

5. (canceled)

6. The method according to claim 1, wherein fluidisation gas is transferred into the transport zone, typically from a product recovery unit of the fluidised reactor system, to control the circulation rate of the bed material, optionally at more than one region.

7. (canceled)

8. The method according to claim 6, wherein the temperature difference between the combustion chamber and the pyrolysis chamber is increased or decreased by changing the ratio of fluidisation gas transferred into a first region of the transport zone relative to a second region of the transport zone.

9. The method according to claim 1, wherein the transport zone comprises a first region to allow the downflow of bed material from the combustion chamber and a second region to allow the upflow of bed material to the pyrolysis chamber.

10. The method according to claim 9, wherein fluidisation gas is transferred into an upstream portion of the second region and into a downstream portion of the second region, wherein the velocity of the fluidisation gas in the upstream portion and/or downstream portion may be from 0.5 to 3 m/s.

11. The method according to claim 6, wherein the velocity of the fluidisation gas in the transport zone is from 0.5 to 3 m/s.

12. (canceled)

13. The method according to claim 1, wherein fluidisation gas is transferred into the pyrolysis chamber, typically from a product recovery unit of the fluidised reactor system, to control the circulation rate of the bed material, wherein the velocity of the fluidisation gas in the pyrolysis chamber is from 3 to 7 m/s.

14. (canceled)

15. The method according to claim 1, further comprising transferring the depolymerised polymer product gas into a product recovery unit and isolating the one or more monomers, optionally wherein one or more of the following applies:
non-condensable gas and/or an energy source is isolated from the depolymerised polymer product gas,
at least a portion of the non-condensable gas and/or energy source that is isolated from the depolymerised polymer product gas is transferred to the combustion chamber,
flue gas from the combustion chamber and at least a portion of the non-condensable gas and/or the energy source that is isolated from the depolymerised polymer product gas is transferred from the product recovery unit to a heat recovery system, wherein the heat recovery system comprises an afterburner,
at least a portion of the non-condensable gas and/or the energy source that is isolated from the depolymerised polymer product gas is transferred to the pyrolysis chamber to fluidise the pyrolysis chamber, further optionally wherein
olefins present in the non-condensable gas and/or the energy source are hydrogenated prior to being transferred to the pyrolysis chamber,
at least a portion of the non-condensable gas and/or the energy source that is isolated from the depolymerised polymer product gas is used for the production of hydrogen and/or olefins,
dimers and trimers are isolated from the depolymerised polymer product gas and transferred the dimers and trimers to the pyrolysis chamber.

16.-23. (canceled)

24. The method according to claim 1, wherein the combustion chamber is run sub-stoichiometrically.

25. The method according to claim 1, wherein the feedstock is provided as flakes with a thickness of from 0.25 to 3 mm, and/or wherein at least 50% of the feedstock is provided as flakes.

26. (canceled)

27. A method for depolymerising polymers in a feedstock, comprising 60% or more polymers by weight of the feedstock, into one or more monomers, the method comprising subjecting the feedstock to a pyrolysis process in a fluidised reactor system comprising a pyrolysis chamber, a combustion chamber, and bed material that circulates from the combustion chamber to the pyrolysis chamber via a transport zone.

28. The method according to claim 27, wherein one or more of the following applies:
the pyrolysis process is executed at a temperature in the range of from 450 to 650° C. in the bed material to obtain the depolymerised polymer product gas comprising the monomers,
a temperature difference between the combustion chamber and the pyrolysis chamber is regulated by changing the ratio of fluidisation gas transferred into a first region of the transport zone relative to a second region of the transport zone,
a temperature difference between the combustion chamber and the pyrolysis chamber is increased or decreased by changing the circulation rate of the bed material.

29. (canceled)

30. (canceled)

31. The method according to claim 1, wherein the feedstock comprises 60-100% polystyrene, by weight of the total polymers in the feedstock.

32. The method according to claim 1, wherein non-condensable gas and/or an energy source is isolated from the depolymerised polymer product gas, and wherein flue gas from the combustion chamber and 40 to 75% of the non-condensable gas and/or the energy source, by weight of the total non-condensable gas and/or the energy source from the product recovery unit to a heat recovery system, wherein the heat recovery system comprises an afterburner.
